(19) United States
(12) Patent Application Publication
(10) Pub. No.: US 2007/0231782 A1
(43) Pub. Date: Oct. 4, 2007

(54) Computer readable recording medium recorded with learning management program, learning management system and learning management method

(75) Inventors: Noriaki Ozawa, Kawasaki (JP); Satoshi Naoi, Kawasaki (JP); Hiroto Toda, Kawasaki (JP); Osamu Iemoto, Osaka (JP)

Correspondence Address: Patrick G. Burns, Esq.;GREER, BURNS & CRAIN, LTD., Attorneys At Law, 300 South Wacker Drive, 25th Floor, Chicago, IL, 60606, US

(73) Assignees: FUJITSU LIMITED; Osamu Iemoto

(21) Appl. No.: 11/712,352

(22) Filed: Feb. 28, 2007

(30) Foreign Application Priority Data
Mar. 31, 2006 (JP) 2006-096288
Sep. 25, 2006 (JP) 2006-259517

(51) Int. Cl. G09B 3/00

(52) U.S. Cl. 434/350

(57) ABSTRACT

Learning material information containing a fixed attribute specifying learning materials and a variable attribute by which at least levels specifying an object person of learning are defined, is registered in a database of a learning material management system. When the learning request is received by the system from a learning applicant, with reference to the variable attribute of the learning material information registered in the database, a learning material adapted to a level of the learning applicant according to the learning request is selected to be provided for the learning applicant, and on the other hand, the variable attribute of the learning material information registered in the database is updated according to a learning result of the learning material by the learner.

### BACKGROUND OF THE INVENTION

1. Field of the Invention

The present invention relates to a learning management technology for comprehensively supporting the preparation of learning materials, the learning and the management of learning result, using a computer.

2. Description of the Related Art

A learning management system utilizing a computer has been developed for the purpose of aiding, by means of a computer, the support of learning which is not sufficiently achieved by only one teacher in case where the teacher must deal with a large number of learners. In such a learning management system, as disclosed in Japanese Unexamined Patent Publication No. 2003-66818, a configuration is adopted in which searched keywords, levels and the like are defined as an attribute (metadata) as being related to learning materials, and by utilizing this attribute, a learning material considered to be suitable for a learner is selected to be provided.

However, in the conventionally proposed technology, the attribute defined as being related to the learning materials is the one statically and unambiguously defined based on a provider's judgment, and therefore, if there is a difference of recognition between the provider and the learner, a learning material suitable for the learner may not be necessarily provided. Briefly explaining such a typical example, it is assumed that, for example, a learning material defined by the provider as “for the intermediate level”, is practically used by a large number of beginners, and also, can be sufficiently understood by the beginners. On this precondition, in the case where the learner seeks a learning material for beginners, since the level defined by the provider is not proper, the learning material defined as “for the intermediate level” is not found out when the search is performed, and accordingly, cannot be learned by the learner.

In view of the conventional problems, the present invention has an object to provide a learning management technology for enabling the definition of a variable attribute as being related to learning materials, to dynamically update the defined variable attribute according to a learning result, to thereby provide a learning material suitable for a learner.

### SUMMARY OF THE INVENTION

In order to achieve the above object, in a learning management technology according to the present invention, learning material information comprising: a fixed attribute specifying learning materials; and a variable attribute for which at least levels specifying object person of learning are defined, is registered in a database. Then, when the learning request is received from a learning applicant, reference is made to the variable attribute of the learning material information registered in the database, in order to select and provided a learning material suitable for a level of the learning applicant according to the learning request, and at the same time, the variable attribute of the learning material information registered in the database is updated according to a result of learning of the learning material by the learner.

According to the learning management technology of the present invention, the variable attribute of the learning material information, that is, the levels specifying object person of learning, is dynamically updated according to the learning result of the learning material. Therefore, even if a level defined by a learning material provider is improper, this level is appropriately and correctively revised to a proper level. Thus, for example, if a learning material defined by the provider as “for the intermediate level”, is understandable even for a beginner, the level of such a learning material is revised to “for the entry level”, and in the provision of learning materials in the next time or later, the learning material of which level is revised to “for the entry-level” will be provided for beginners. Consequently, the learning materials can be effectively utilized by the learning material provider, and at the same time, an individual learner can learn the learning material adapted to the person, so that a learning effect can be improved.

The other objects, features, advantages and various aspects of the present invention will become more apparent from the ensuing description of preferred embodiments with reference to the accompanying drawings.

### BRIEF DESCRIPTION OF THE DRAWINGS

FIG. 1 is an entire diagrammatic view illustrating a configuration of a learning management system which realizes the present invention;

FIG. 2 is an explanatory diagrammatic view illustrating learner information and learning material information;

FIG. 3 is an explanatory view illustrating the learner information defined using XML;

FIG. 4 is an explanatory view illustrating the learning material information defined using XML;

FIG. 5 is a flowchart showing the variable attribute update processing;

FIG. 6 is an explanatory view illustrating a state where the variable attribute of the learner information is updated.

FIG. 7 is an explanatory view illustrating a state where the variable attribute of the learning material information is updated;

FIG. 8 is a flowchart showing the learner information update processing;

FIG. 9 is a flowchart showing the keyword registration processing;

FIG. 10 is an explanatory view illustrating states where searched keywords are registered in the variable attribute of the learning material information;

FIG. 11 is an explanatory view illustrating the learner information which is used when a difficulty level of a learning material is offered;

FIG. 12 is an explanatory view illustrating the learning material information which is used when the difficulty level of the learning material is offered;

FIG. 13 is an explanatory view illustrating the learning material information in which a 3-parameter logistic function is defined;

FIG. 14 is an explanatory view illustrating the learning material information in which an event is embedded;

FIG. 15 is an explanatory diagrammatic view illustrating a learning material for generating the event;

FIG. 16 is a flowchart showing the event processing;

FIG. 17 is an explanatory view illustrating the learning material information which calls up a program by a key event;

FIG. 18 is an explanatory view illustrating the learning material information which displays a message by a key event;

FIG. 19 is an explanatory view illustrating the learning material information which counts up the usage frequency of the event;

FIG. 20 is an explanatory view illustrating a keyword map;

FIG. 21 is an explanatory view illustrating the learning material information which defines an interrelation between the learning materials;

FIG. 22 is a flowchart showing the registration processing of the interrelation between learning materials;

FIG. 23 is an explanatory diagrammatic view illustrating the outline of the processing for extracting keywords from a document to make them metadata;

FIG. 24 is a flowchart showing the learning material automatic preparation processing;

FIG. 25 is a flowchart showing the outline of the processing of from the learning start to the learning finish;

FIG. 26 is a diagrammatic view illustrating a configuration to realize the learning suitable for ability of an individual learner;

FIG. 27 is an explanatory view illustrating a dynamically constructed information table;

FIG. 28 is an explanatory view illustrating style information which is embedded in the learning material information;

FIG. 29 is a flowchart of a main-routine of a process providing the learning material adapted to the learner; and

FIG. 30 is a flowchart of a sub-routine of a process providing the learning material adapted to the learner.

### DESCRIPTION OF THE PREFERRED EMBODIMENT

Hereinafter, the present invention will be described with reference to the accompanying drawings.

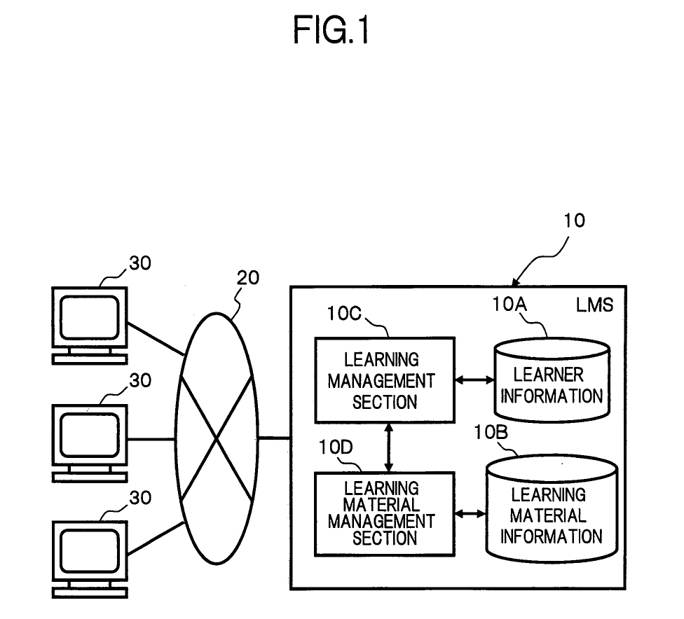

FIG. 1 shows an entire configuration of a learning management system which embodies the present invention.

A learning management system (LMS) 10 is constructed by installing a learning management program recorded in a computer readable recording medium, such as, a CD-ROM, a DVD-ROM or the like, into a general-purpose computer, such as, a server or the like. The learning management system 10 is provided with a learner information DB (database) 10A in which learner information is registered and a learning material information DB 10B in which learning contents (learning materials) and learning material information are registered. Further, in the learning management system 10, by executing the learning management program there are realized, respectively, a learning management section 10C that performs the learner management, the progress management and the setting/grading of an examination, and a learning material management section 10D that searches, refers to and updates the learning materials and the learning material information which are registered in the learning material information DB 10B. Furthermore, the learning management system 10 is interconnected with at least one of clients 30 which are utilized by learners, via a network 20, such as the Internet and the Intranet or the like. Incidentally, the learning material information DB 10B and the learning material management section 10D may be separately disposed on the exterior of the learning management system 10.

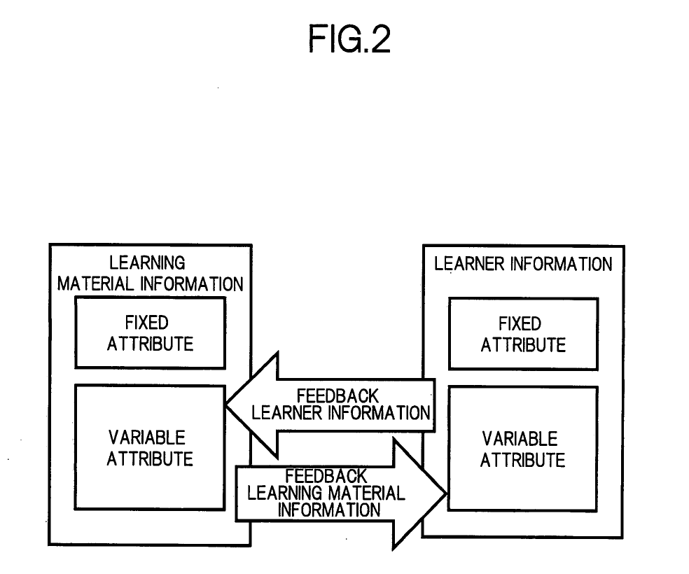

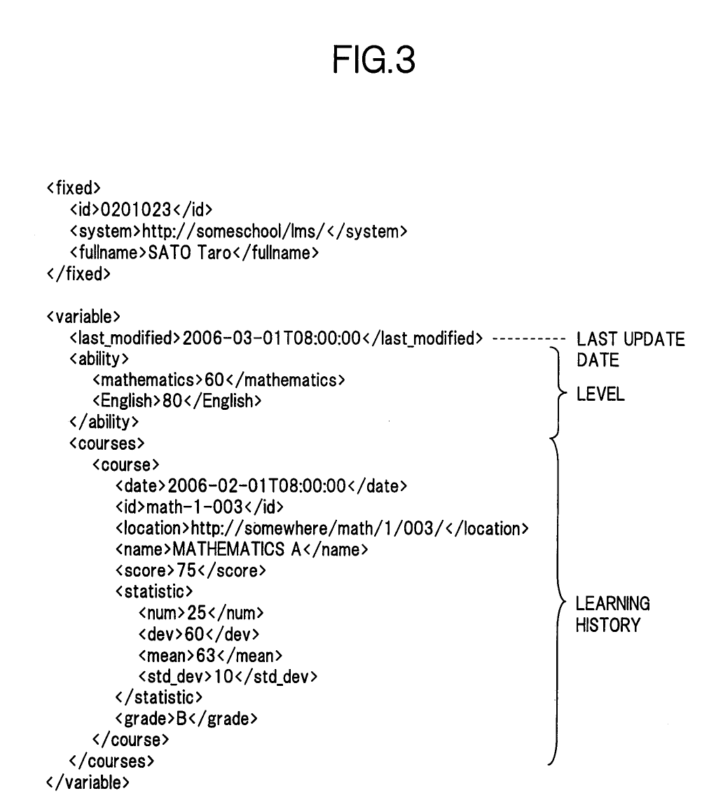

As shown in FIG. 2, the learner information is comprised of a fixed attribute and a variable attribute. The fixed attribute is a static attribute specifying the learners and contains, for example, identifiers, affiliations and names. Further, the variable attribute is a dynamic attribute capable of being updated such as, rewriting, adding and the like, and contains, for example, the last update dates, levels and learning histories of the learning materials. The fixed attribute and the variable attribute can be defined as metadata using XML (extensible Markup Language), as shown in FIG. 3. Here, the level of each learner can be represented by an objective numeral, such as a deviation value, for each subject, using a tag <ability> for example. Note, the fixed attribute and the variable attribute may be defined using line-oriented metadata in place of XML (same will be applied hereunder).

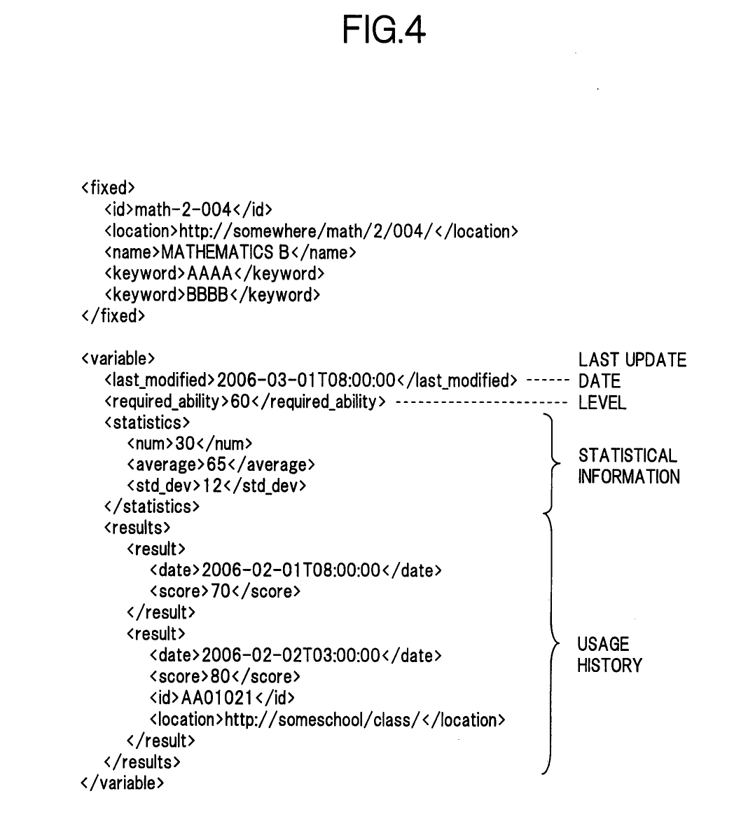

On the other hand, as shown in FIG. 2, the learning material information is comprised of a fixed attribute and a variable attribute. The fixed attribute is a static attribute specifying the learning materials, and contains, for example, identifiers, locations, appellations and at least one searched keyword. Further, the variable attribute is a dynamic attribute capable of being updated such as, rewriting, adding and the like, and comprises, for example, the last update dates, levels, various statistical information, the usage histories, standard learning times, searched keywords and object person of learning. The fixed attribute and the variable attribute can be defined as metadata using XML, as shown in FIG. 4. Here, the level of each learning material can be represented by a numeral comparable with the level of the learner, using a tag <required ability> for example.

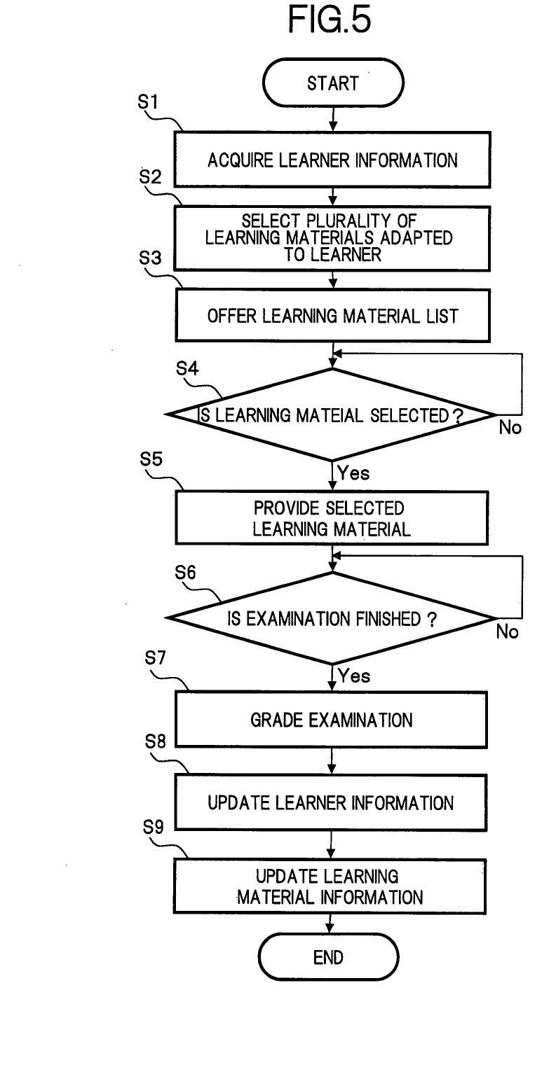

FIG. 5 shows the variable attribute modification processing which is executed by the learning management section 10C and the learning material management section 10D in corporation with each other, when a learning applicant logs into the client 30 and the learning management system 10 receives the learning request. Incidentally, it is assumed that an identifier specifying the learner and search keywords contributing to the selection of the learning material are contained in the learning request.

In step 1 (to be abbreviated as “S1”, and the same rule will be applied to subsequent steps), the learner information corresponding to the identifier of the learner is acquired by referring to the learner information DB 10A.

In step 2, a plurality of learning materials suitable for the learner is selected. Namely, reference is made to the learning material information DB 10B, so that the search keywords and the levels contained in the variable attribute of the learner information, are matched, respectively, with the searched keywords contained in the fixed attribute of the learning material information and the levels contained in the variable attribute thereof, to thereby select the plurality of learning materials considered to be suitable for the learner.

In step 3, a learning material list is offered to the learner.

In step 4, it is determined whether or not a learning material that the learner desires to learn is selected by the learner. Then, if the learning material is selected, the processing proceeds to step 5 (Yes), while if no learning material is selected, the processing stands by in step 4 (No).

In step 5, the selected learning material is provided for the learner.

In step 6, it is determined whether or not an examination contained in the learning material is finished. Then, if the examination is finished, the processing proceeds to step 7 (Yes), while, if the examination is not yet finished, the processing stands by in step 6 (No).

In step 7, the examination is graded.

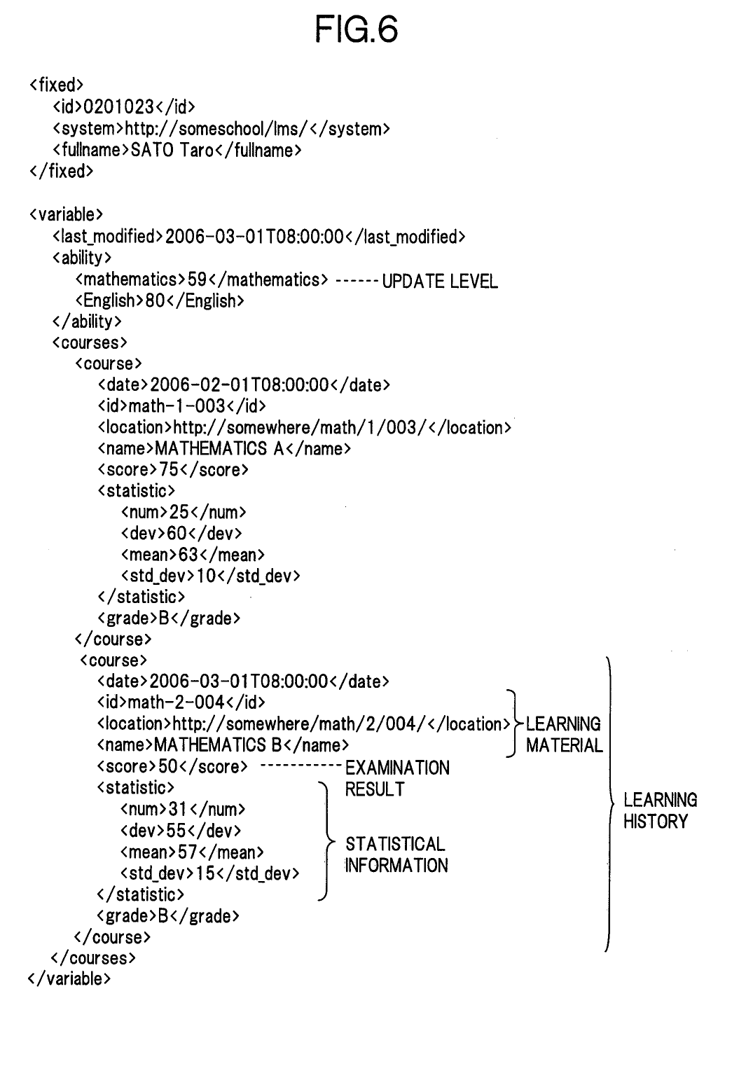

In step 8, as shown in FIG. 6, the learning material learned by the learner, an examination result and the statistical information are additionally-registered, as a learning history, in the variable attribute of the learner information registered in the learner information DB 10A. In the example shown in FIG. 6, it is registered that the learner selected mathematics B and the examination result was 50 points, and also, as the statistical information of all learners of mathematics B, the population thereof was 31, the deviation value was 55, the average score was 57 points and the standard deviation was 15. Further, according to the examination result, the level of the learner is appropriately updated.

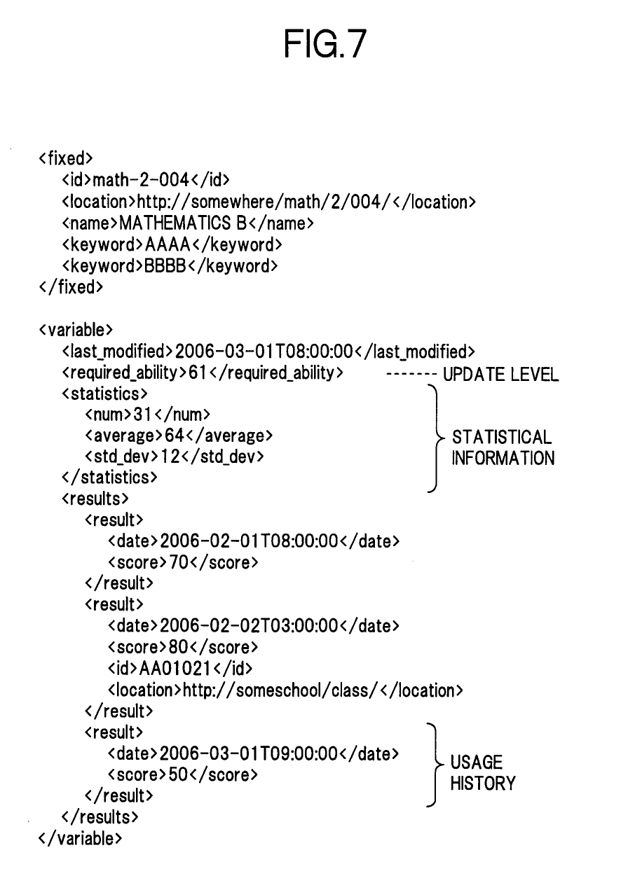

In step 9, as shown in FIG. 7, a usage history of the learner is additionally registered in the variable attribute of the learning material information registered in the learning material DB 10B. Further, the statistical information of the variable attribute is appropriately updated according to the examination result of the learner. In the example shown in FIG. 7, it is registered that the examination result of the learner was 50 points, and also, as the statistical information of all the learners, the population thereof was 31, an average score was 64 and the standard deviation was 12. Incidentally, in the usage history, if the information specifying the learner is not disclosed, only the time and date of the examination and the examination result may be registered. Further, the level of the objective learner is appropriately updated according to the examination result. Namely, when the examination result of the learner is significantly lower or higher than an examination result according to a level set by a learning material provider, it is possible to determine that the set level is improper. In this case, the level is appropriately updated according to the examination result of the learner, so that a learning material appropriate for the learner can be provided.

According to the variable attribute update processing as described above, reference is made to the learner information DB 10A and the learning material information DB 10B, and the list of the plurality of learning materials adapted to the search keywords and the level is provided. Then, when the learning material that the learner desires to learn is selected from the list, the selected learning material is acquired from the learning material information DB 10B to be provided for the learner. At this time, the learner eventually selects the learning material to learn, and therefore, can surely select the learning material that is actually desired to learn. Further, when the examination for grasping a learning result of the learning material is finished, according to a learning fact and the examination result, the variable attributes of the learner information and the learning material information are appropriately updated. At this time, since the level of the learning material is dynamically changed according to the examination result of the learner, if the learning material defined by the learning material provider as “for the intermediate level” for example is understandable even for beginners, the level of such a learning material is revised to “for the entry level”, and in the provision of the learning materials in the next time or later, the learning material of revised level is provided for the beginners. Consequently, the learning materials can be effectively utilized by the learning material provider, and at the same time, the learner can learn the learning material well adapted to that person and as a result, a learning effect can be heightened.

Here, when the learning material appropriate for the learner is selected in step 2, if the usage history is registered in the variable attribute of the learning material information, a level computed based on the usage history, in place of the level registered in the variable attribute, may be made an object to be matched. The level registered in the variable attribute is calculated based on the learning results of all the learners who learned the learning material, so as to be given with the objectivity, and therefore, there is a possibility that such a level is not necessarily proper. Namely, when the level of the learner is gradually improved, there are supposed various requests, such that a level calculated based on learning results of recent learners is to be made the object to be matched, or such that since there is a possibility that influences by learners of improper levels might be reflected on the registered level, a level calculated based on learning results of learners whose levels are approximately even with the level of the learning applicant is to be made the object to be matched, and so forth.

In the case of the former request, the refinement is performed in the usage histories registered in the variable attribute of the learning material information by the filtering using the learning time and date, and a level recalculated based on the refined usage histories may be made the matching object. On the other hand, in the case of the latter request, if the information specifying the learners is registered in the usage history, reference is made to the learning information of the learners, and the usage histories of the learners whose levels are close to the level of the learning applicant are refined from the usage histories registered in the variable attribute of the learning material information, so that a level recalculated based on the refined usage histories may be employed as the object to be matched.

Thus, by employing the level calculated based on the learning results of the learners refined from all the learners who learned the learning material according to a predetermined rule as the object to be matched, it becomes possible to perform the matching in response to the various requests, thereby enabling the selection of the learning material further appropriate for the learning applicant.

Further, the learning histories are sequentially registered in the variable attribute of the learner information, so that the learner information can be reviewed at arbitrary times. For example, assuming that, at the time when Mr. SATO being a learner learned “mathematics B”, learners of “mathematics A” that he learned before then are increased, so that an average score of “mathematics A” is lowered. Mr. SATO who is deemed to have the learning result of not so good at the learning time of mathematics A, may actually have a good learning result. Therefore, it becomes necessary to recalculate the statistical information of the learning histories to thereby appropriately update the variable attribute of the learner information.

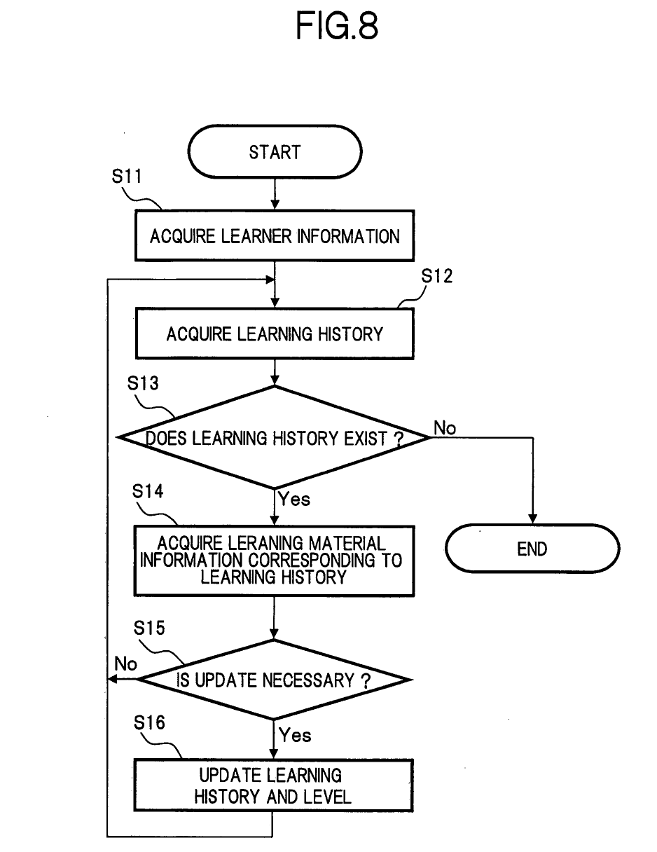

FIG. 8 shows the learner information update processing executed by designating the learner being an update object.

In step 11, reference is made to the learner information DB 10A, and the learner information of such a learner is acquired.

In step 12, the learning histories are sequentially acquired from the variable attribute of the learner information.

In step 13, it is judged whether or not the learning histories could be acquired, that is, whether or not all the learning histories were processed. Then, if the learning histories could be acquired, the processing proceeds to step 14 (Yes), while if the learning histories could not be acquired, the processing is terminated (No).

In step 14, reference is made to the learning material information DB 10B, and, for example, the learning material information specified by a tag <id> contained in the learning histories is acquired, as the learning material information corresponding to the learning histories.

In step 15, it is determined based on the variable attributes of the learner information and the learning material information whether or not it is necessary to update the learner information. As the specific determination processing thereof, reference is made to the usage histories in the learning material information, and when a predetermined time has elapsed from the latest learning time and date, it is possible to determine that it is necessary to update the learner information. Or, reference is made to the statistical information in each of the learner information and the learning material information, when the learners are increased by predetermined numbers, it is possible to determined that it is necessary to update the learner information. Then, if it is determined that it is necessary to update the learner information, the processing proceeds to step 16 (Yes), while it is judged that it is not necessary to update the learning information, the processing returns to step 12 (No).

In step 16, using the usage history in the learning material information, the statistical information of the learning history in the learner information is recalculated. Further, when it is necessary to change the level of the learner with the recalculation of the statistical information, the level of the learner is also updated.

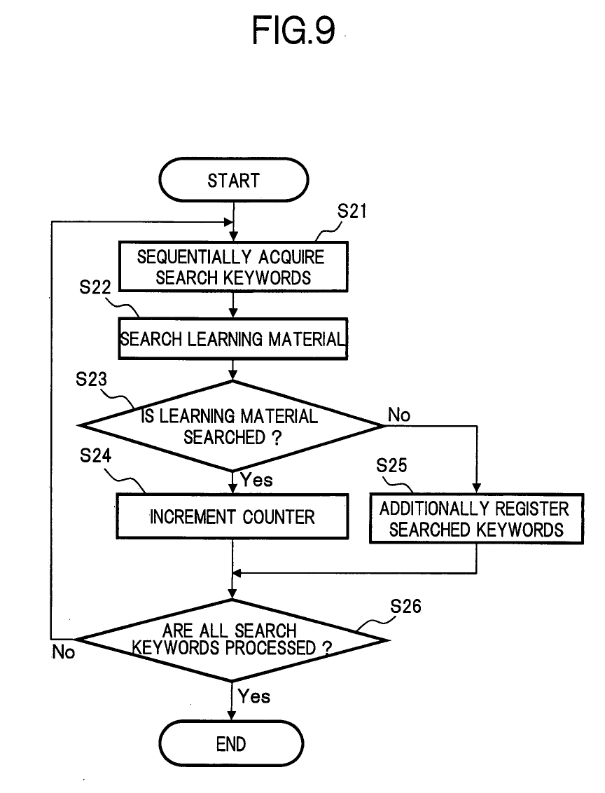

FIG. 9 shows the keyword registration processing which additionally registers searched keywords as the variable attribute of the learning material information registered in the learning material information DB 10B, in response to the learning request.

In step 21, the search keywords contained in the learning request are sequentially acquired.

In step 22, reference is made to the learning material information DB 10B and, the learning materials are searched using the acquired search keywords as keys.

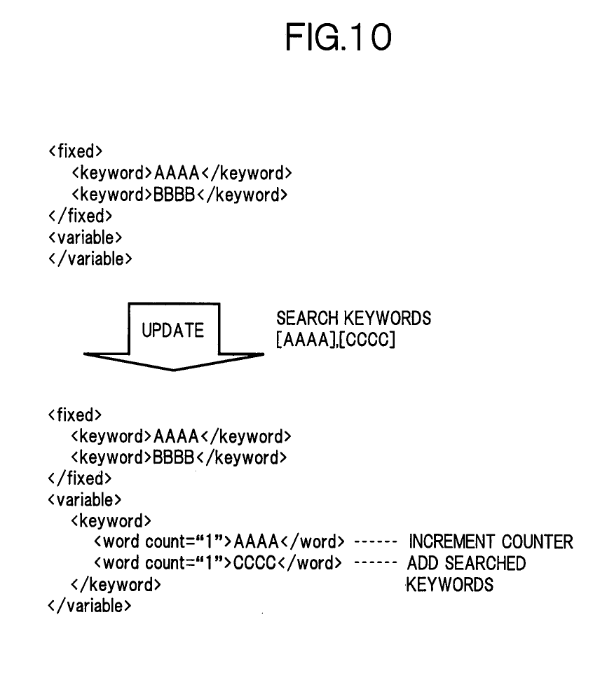

In step 23, it is determined whether or not the learning materials could be searched. Then, if the learning materials could be searched, the processing proceeds to step 24 (Yes), where as shown in FIG. 10, a counter of a tag <word count> which counts up the usage frequency of the searched keywords, is incremented as the variable attribute of the learning material information. On the other hand, if the learning materials could not be searched, the processing proceeds to step 25 (No) where as shown in FIG. 10, the searched keywords are additionally registered in a tag <keyword> as the variable attribute of the learning material information, and also, the counter of the tag <word count> is set to 1.

In step 26, it is judged whether or not all the search keywords are processed. Then, if all the search keywords are processed, the process is terminated (Yes), while if all the search keywords are not yet processed, the processing returns to step 21 (No).

According to the keyword registration processing as described above, when the search keywords designated by the learning applicant are not defined as the fixed attribute of the learning material information, these search keywords are additionally registered in the variable attribute of the learning material information. For example, as shown in an upper stage of FIG. 10, it is assumed that, searched keywords statically and unambiguously defined by the learning material provider as the fixed attribute of the learning information of a learning material A, are “AAAA” and “BBBB”. Then, when search keywords “AAAA” and “CCCC” are designated in order to search the learning material A, as shown in a lower stage of FIG. 10, the search keyword “CCCC” which is not defined as the fixed attribute of the learning material information, is additionally registered in the variable attribute of the learning material information. Therefore, in the learning material search after then, the additionally-registered searched keyword contributes to the search, and a percent hit rate of the search can be improved.

Further, as the variable attribute of the learning material information, the usage frequency of the searched keywords is counted up. Therefore, for example, if the searched keywords as the variable attribute are sorted in descending order according to the counted value of the usage frequency, the search efficiency can be improved. On the other hand, when the learning material list is offered to the learning applicant without sorting the searched keywords as the variable attribute, if a sequence in which the learning materials is displayed is changed according to the usage frequency of the searched keywords, the selection efficiency by the learning applicant can be improved.

Next, there will be provided a description of an application example using the variable attributes of the learner information and the learning material information.

### (1) Offering the Difficulty Level of the Learning Material

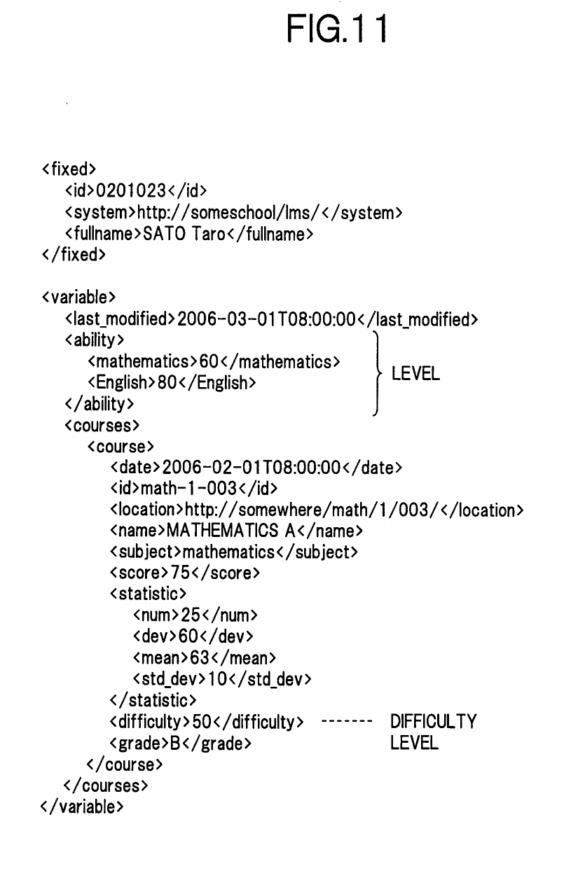

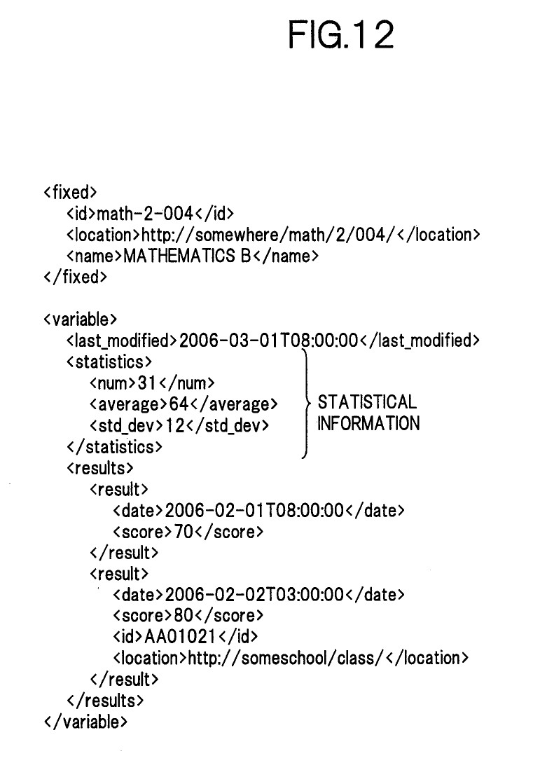

It is also possible to offer the difficulty level of the learning material in relation to the level of the learner, utilizing the learning history registered in the variable attribute of the learner information. Regarding the level of the learner, as shown by a tag <ability> in FIG. 11, for example, the deviation value computed based on the examination results in the learning histories may be used. On the other hand, as shown in FIG. 12, the statistical information of the examination results is registered in the variable attribute of the learning material information, to be compared with the level of the learner, so that it is able to determine whether or not the learning material is adapted to the learner.

Then, it is preferable that the level of the learner is extracted from the learner information, and at the same time, the understanding level of the learning material is computed based on the examination result of the learning material, so that the correlation between the level of the learner and the understanding level of the learning material is registered in the variable attribute of the learning information. Consequently, by referring to the learner information and the learning material information, it becomes possible to make an offer of “too easy” or “too difficult” or to offer the learning material of proper difficulty level, to the learning applicant.

Here, there will be shown a practical example in which the difficulty level of the learning material is computed based on a 3-parameter logistic function, utilizing the relation between the level of the learner and the examination result of the learning material. The 3-parameter logistic function is a function which is used in IRT (Item Response Theory) or the like for computing the capability of scoring to an ability value, and is defined by three parameters a, b and c as shown in the next equation.

$${p}_{j} ( θ ) = {c}_{j} + ( 1 - {c}_{j} ) \frac{1}{1 + exp ( - {Da}_{j} ( θ - {b}_{j} ) )}$$

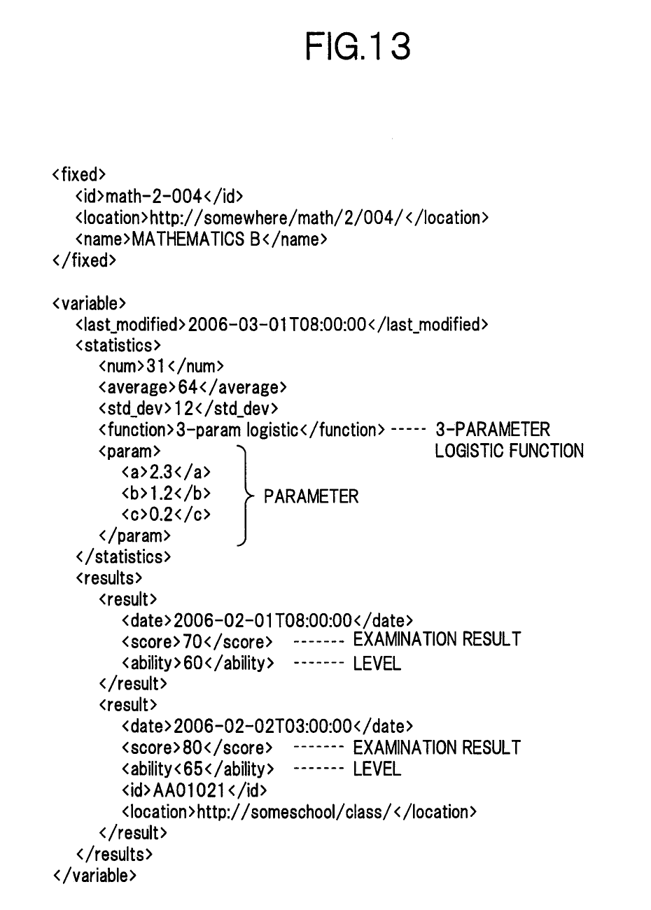

Parameters appropriate for this function are obtained based on the relation between the level of the learner and the examination result of the learning material, and as shown in FIG. 13, if the obtained parameters are registered in the variable attribute of the learning material information, the difficulty level can be easily computed. To be specific, the level of the learner and the examination result of the learning material are once registered in the variable attribute of the learning material, and at each time when the learning is finished, the parameters may be computed.

### (2) Embedding an Event in the Learning Material

In order to utilize the same information among different learning management systems, it is possible to embed any update measure such as an update procedure, an update program and the like, as to how each item is updated, in the learning material utilizing the variable attribute. Namely, the variable attribute of the learning material information contains “event definition” defining a condition on which the update is made, “event handler” defining a program by which the update is executed, and “event procedure” defining which attribute is updated and how the update is made.

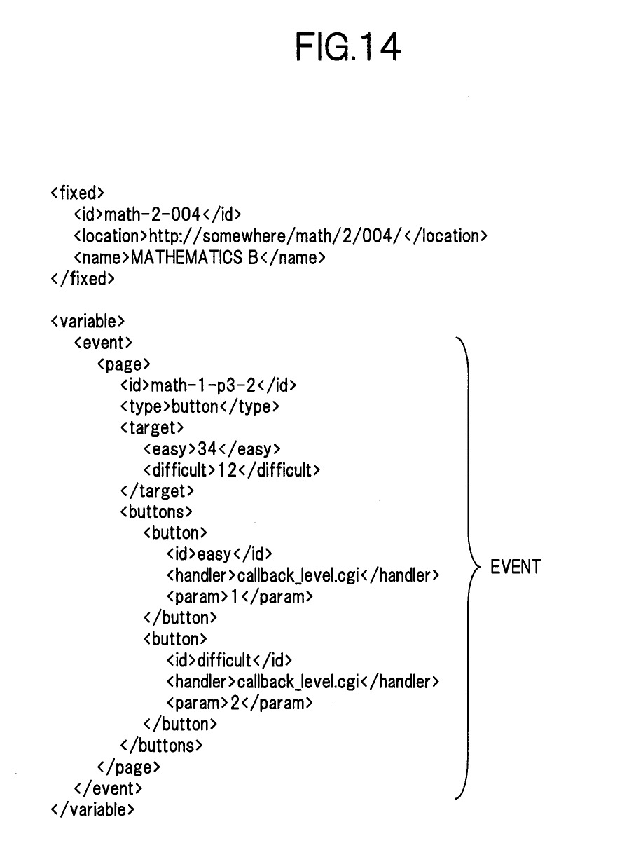

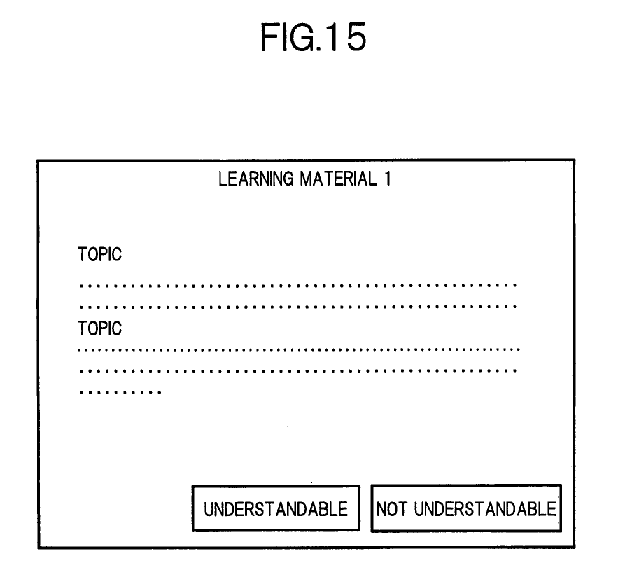

In order to realize the learning material, which can feedback estimation of the contents, for example, the variable attribute of the learning material information may be defined as shown in FIG. 14. This figure shows an example in which, in a learning material “math-2-004”, an event is embedded in a page specified by “math-1-p3-2”. As shown in FIG. 15, two buttons are contained in this learning material. Then, transition of the page is executed by estimating whether the explanation of the learning material could be understood or could not be understood, via the buttons. When one of the two buttons is clicked, an argument 1 or 2 is given to a program “callback_lebel.cgi”, and a counter of a tag <easy> or <difficult> in a tag <target> is incremented. Further, if this estimation information is sequentially registered in the variable attribute of the learning material information, this estimation information can be used as an index when the representation and composition of the learning material is reviewed.

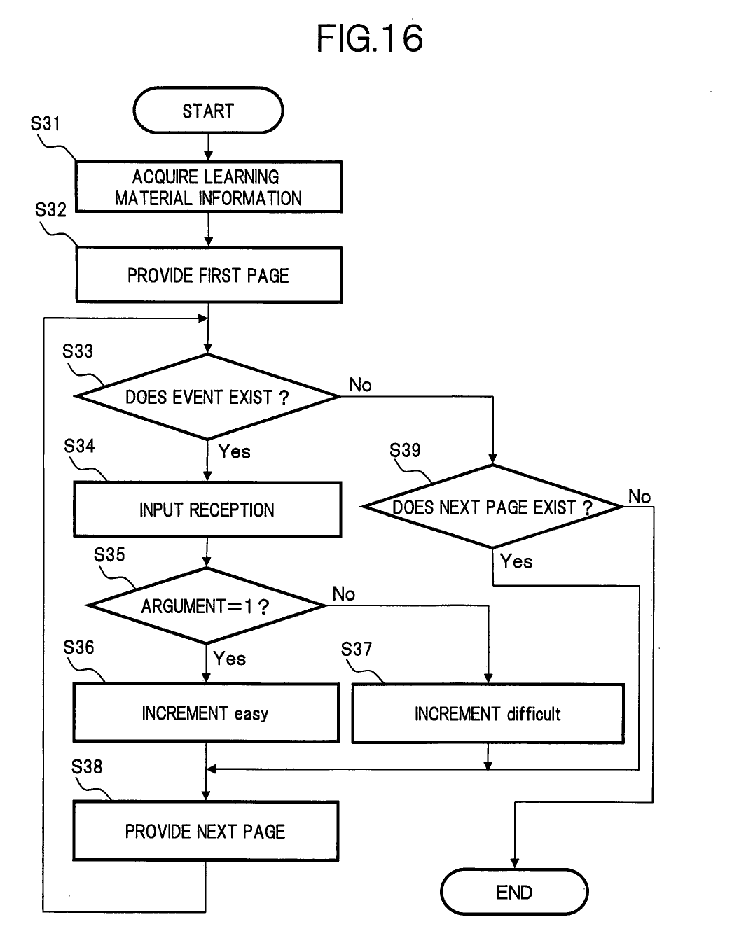

FIG. 16 shows the processing of the event embedded in the learning material.

In step 31, with reference to the learning material information DB 10B, the learning material information is acquired.

In step 32, a first page as shown in FIG. 15 is provided.

In step 33, it is judged whether or not an event is embedded, via whether or not a tag <event> is defined as the variable attribute of the learning material information. Then, if the event is embedded, the processing proceeds to step 34 (Yes), while if the event is not embedded, the processing proceeds to step 39 (No).

In step 34, the processing waiting for input reception, namely, stands by until the button on the page is clicked.

In step 35, it is judged whether or not the argument is 1, namely, whether or not the button “understood” is clicked. Then, if the argument is 1, the processing proceeds to step 36 (Yes), where the counter of the tag <easy> is incremented. On the other hand, if the argument is not 1, the processing proceeds to step 37 (No), where the counter of the tag <difficult> is incremented.

In step 38, after the next page is provided, the processing returns to step 33.

In step 39, it is determined whether or not a further page exists. Then, if the further page exists, the processing proceeds to step 38 (Yes), while if the further page does not exist, the processing is terminated (No).

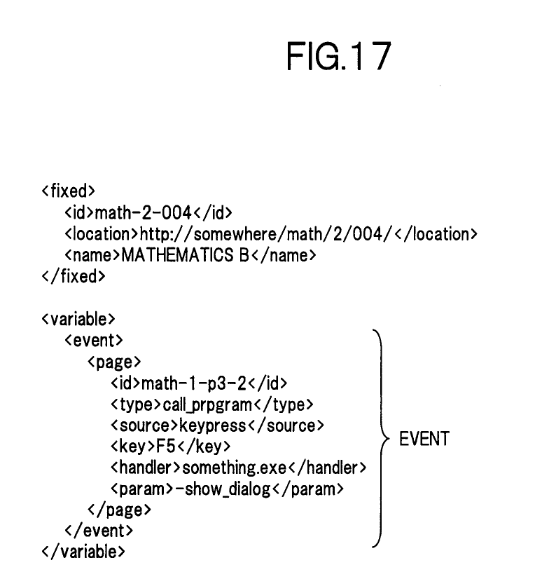

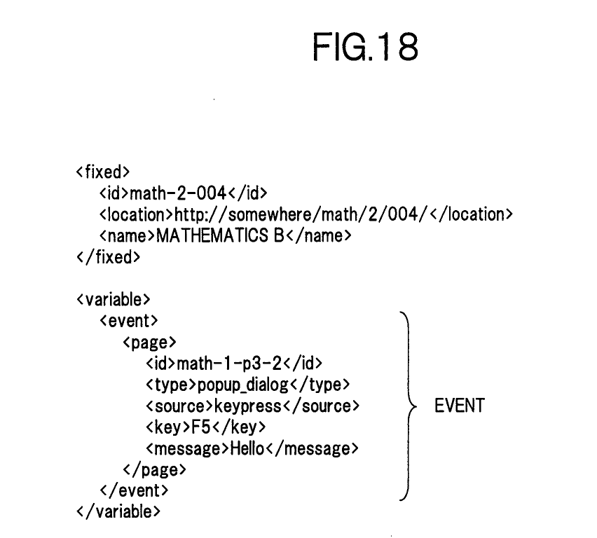

Further, in order to realize the learning material which can call up instructions and applications, for example, the variable attribute of the learning material information may be defined as shown in FIG. 17. This figure shows an example in which, when “F5” key is pressed, a program “something.exe” is called up by an argument “-show_dialog”. Furthermore, when a message “hello” is displayed in a pop-up window by the “F5” key, the variable attribute of the learning material information may be defined as shown in FIG. 18. For example, this can be applied to the display of hints or explanations. Other than the above, the configuration may be such that keywords in the learning material are made clickable, and if any one of the keywords is clicked, the detailed explanation thereof is displayed.

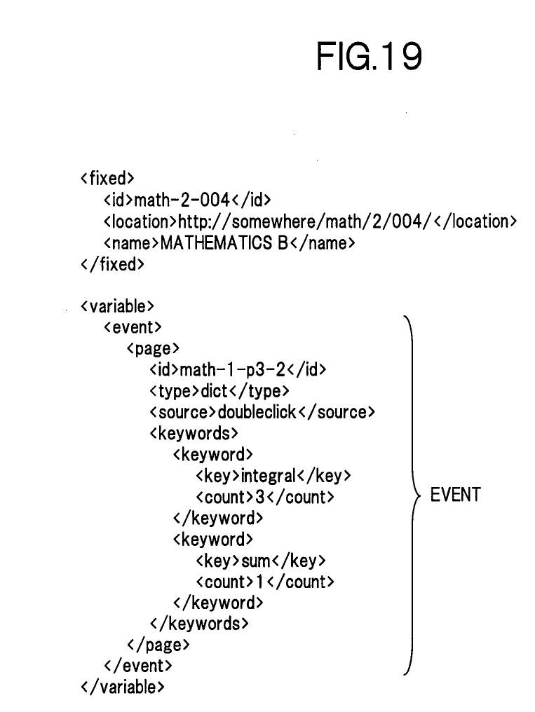

If the usage frequency of the event is registered in the variable attribute of the learning material information, the correlation between the explanatory contents of the learning material and the keywords thereof is obtained, so that the points to be noticed, portions lacking enough explanation and the like with respect to the learning material can be grasped. For example, when the frequency of even requesting the explanation of a certain keyword is high, it is possible to analyze that the explanation is insufficient for such a keyword, the supposed learner's level is not appropriate for the learning material, or the like. In this case, the variable attribute of the learning material information is defined as shown in FIG. 19.

Thus, by utilizing the variable attribute of the learning material information, the possibility of utilizing the learning materials becomes greater. Further, by commonly using the information obtained in the above manner without limiting the learning management systems or the learners, the further objective estimation and utilization of the information become possible.

On the other hand, a learning material preparation system may easily define the event definition, the event handler, the event procedure and the like. For example, a button, a region or the like may be designated using a GUI (Graphical User Interface) and also, the processing to be executed may be selected from a menu, so as to be registered seamlessly as the variable attribute of the learning material information.

### (3) Description of a Relation Between Data

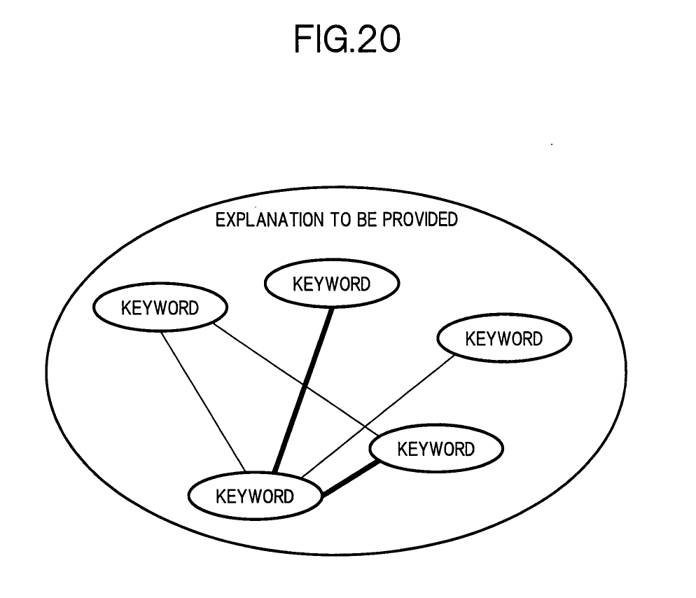

In the learning material information, a relation between the learning materials or a relation between the data may also be defined. To the specific, as the variable attribute of the learning material information, how the relation between the data is, and the strong/weak and the like of the relevance thereof, are registered, to be reflected when the relation therebetween is changed. For example, it is possible to define the relation between the data by a RDF or the like. Then, by utilizing the relation between the data, it becomes possible to prepare a keyword map as shown in FIG. 20 for each learning material, and the prepared keyword map can be utilized from the learning management system and the learning materials. In the keyword map, a relation between the explanatory contents of the learning material and the keywords is made to be a graph structure, and the strength of the relevance thereof is registered in the variable attribute. Therefore, the keywords and the explanations thereof can be estimated. Further, it is desirable that the weight indicative of the strength of the relevance is given to each side which connects between keywords, and the weight is appropriately updated according to the usage frequency of the keywords, search conditions and the like. As utilization examples of the keyword map, the learning materials are automatically prepared based on syllabi and books by the learning material provider, on the other hand, the explanations and the learning materials relating to the keywords can be easily obtained by the learners.

If, the usage frequencies, access sites and the like are registered for the learning materials having such a relation with respect to one another as described above, a relevance map between the learning materials can be prepared. Then, by correlating with the examination results of the learning materials, it becomes possible to grasp tendency of learning material with an effective combination of which learning material to be learned for upgrading the understanding level.

Here, there will be provided a description of the preparation of the relevance map of the learning material.

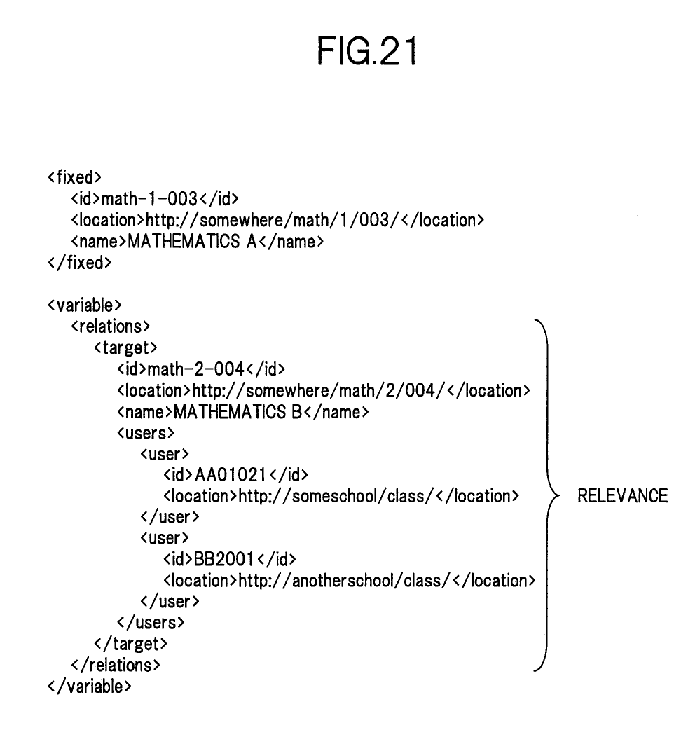

In the case where the learner information is registered in the usage history of the learning material, if the learning history of the learner is referred to, it is possible to grasp, for example, that the same learner utilizes the learning material A and a learning material B in a set many times, and so on. To be specific, the learning material information shown in FIG. 21 indicates that the learner of the learning material “mathematics A” specified by “http://somewhere/math/1/003” and “math-1-003” learns also the learning material “mathematics B” specified by “http://somewhere/math/2/004” and “math-2-004”, and also indicates that the learners of “mathematics B” are two persons of “AA01021” in “http://someschool/class/” and “BB2001” in “http://anotherschool/class/”.

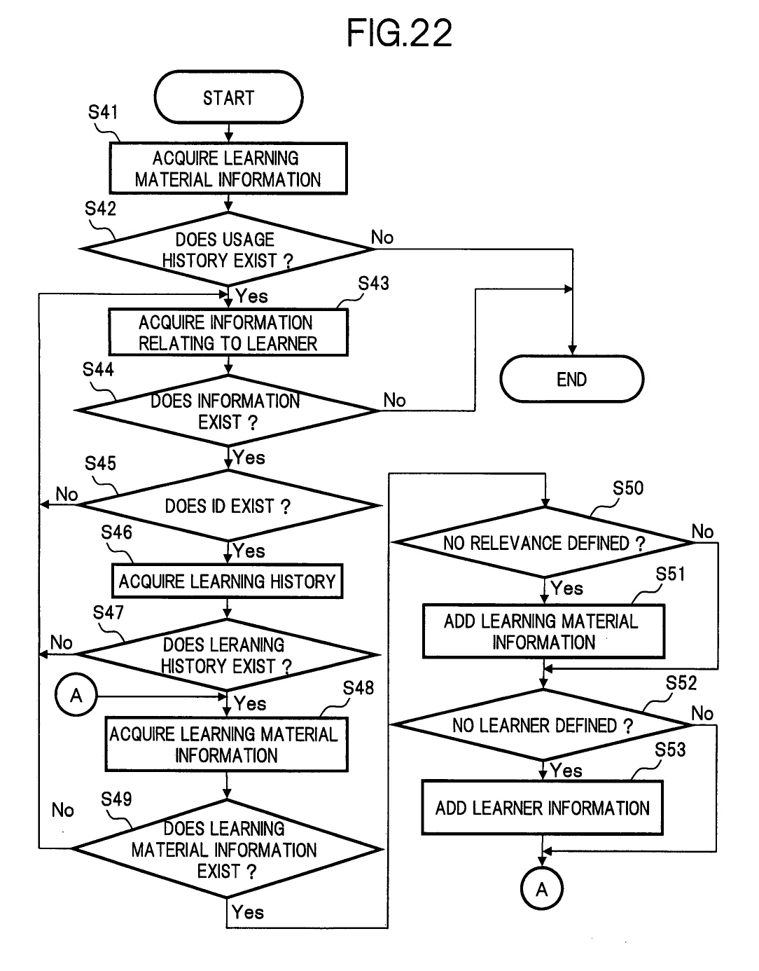

FIG. 22 shows the processing of registering the interrelation between the learning materials. Incidentally, when the interrelation between the learning materials is prepared, it is necessary to process all the learning materials.

In step 41, reference is made to the learning material information DB 10B, and the learning material information of the learning material to be processed is acquired.

In step 42, it is determined whether or not the usage history is registered in the learning material information. Then, if the usage history is registered, the processing proceeds to step 43 (Yes), while if the usage history is not registered, the processing is terminated (No).

In step 43, the information relating to the learners is sequentially acquired from the usage history.

In step 44, it is determined whether or not the information relating to the learners could be acquired, that is, whether or not the processing is finished for all the learners registered in the usage history. Then, the information relating to the learners could be acquired, the processing proceeds to step 45 (Yes), while if the information could not be acquired, the processing is terminated (No).

In step 45, it is determined whether or not an ID is registered in the information relating to the learners, that is, whether or not the identifier specifying the learner is registered. Then, if the ID is registered in the information relating to the learners, the processing proceeds to step 46 (Yes), while if the ID is not registered in the information, the processing returns to step 43 (No).

In step 46, with reference to the learner information DB 10A, the learning history of the learner specified by the ID is acquired.

In step 47, it is determined whether or not the learning history could be acquired. Then, if the learning history could be acquired, the processing proceeds to step 48 (Yes), while if the learning history could not be acquired, the processing returns to step 43 (No).

In step 48, with reference to the learning material information DB 10B, the learning material information of the learning material specified by the learning history is acquired.

In step 49, it is determined whether or not the learning material information could be acquired. Then, if the learning material information could be acquired, the processing proceeds to step 50 (Yes), while if the learning material information could not be acquired, the processing returns to step 43 (No).

In step 50, it is determined whether or not the relevance defined exists in the learning material information. Then, if the relevance defined does not exist in the learning material information, the processing proceeds to step 51 (Yes), where relevant learning material information is additionally-registered in the variable attribute of the learning material information. On the other hand, if the relevance defined exists in the learning material information, the processing proceeds to step 52 (No).

In step 52, it is determined whether or not the definition relating to the learner exists in the learning material information. Then, if the definition relating to the learner does not exist in the learning material information, the processing proceeds to step 53 (Yes), where relevant learner information is additionally-registered in the variable attribute of the learning material information. On the other hand, if the definition relating to the learner exists in the learning material information, the processing returns to step 48 (No).

Therefore, by relating the keyword information contained in the learning material related as in the above manner, it is also possible to prepare the keyword map.

### (4) Automatic Preparation of a Learning Material

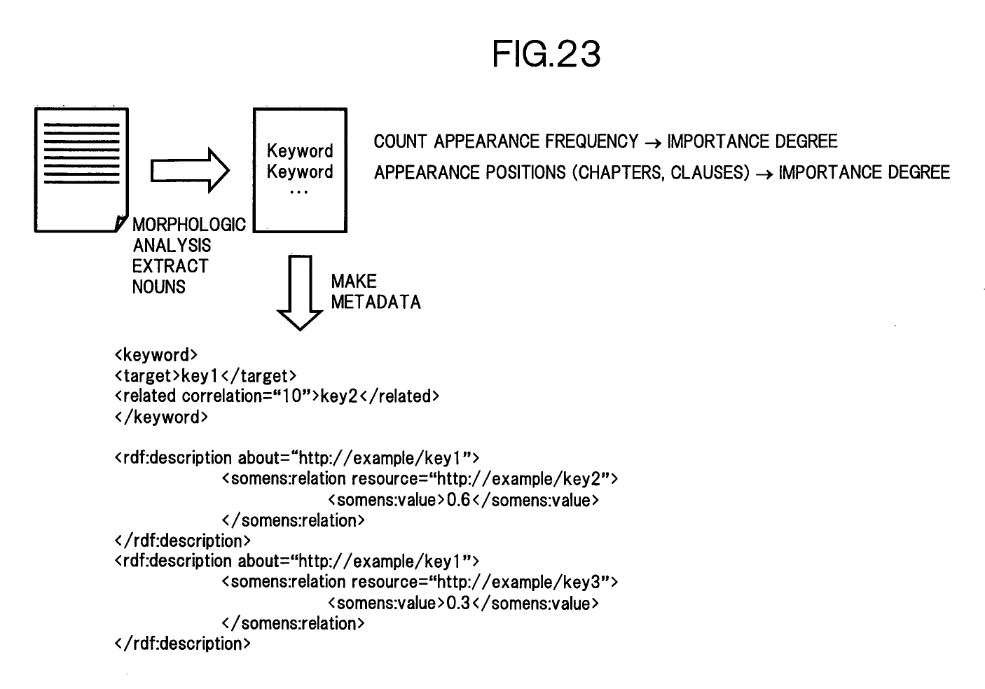

As shown in FIG. 23, keywords are extracted from documents of the syllabi, books and the like, and relations of pages, chapters and clauses on which those keywords appear, are related with each other, based on the appearance frequency of the keywords. Since an entire amount is decided for the number of pages of a learning material to be prepared, it is possible to automatically compose the learning material, using a method of arranging an explanation by giving priority to a keyword being the point so that the explanation falls in the pages allocated for each chapter. Further, it is expected that the learning material prepared as in the above manner shall be properly modified by the provider.

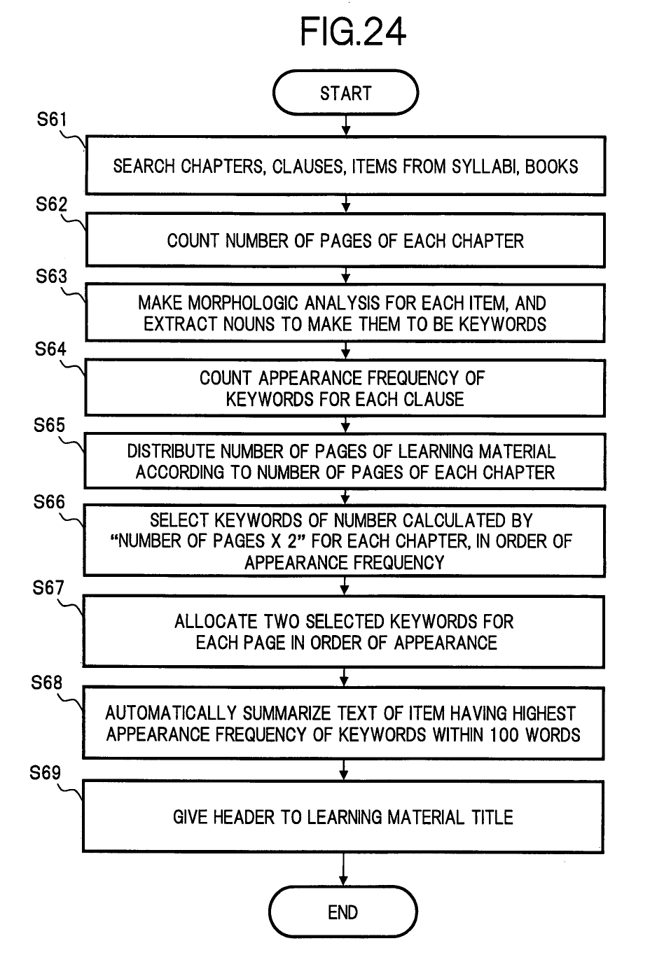

FIG. 24 shows the processing of automatically preparing the learning material.

In step 61, chapters, clauses and items are searched from the syllabi, books and the like.

In step 62, the number of pages of each chapter is counted up.

In step 63, the morphologic analysis is made for each item, and nouns are extracted to be made keywords.

In step 64, the appearance frequency of the keywords is counted up for each clause. At this time, the keywords which are contained in headers or are emphasized are weighted to be counted up.

In step 65, the number of pages of the learning material to be prepared is distributed to each chapter according to the number of pages thereof.

In step 66, the keywords of the numbers calculated by “the distributed number of pages×2” are selected in order of the appearance frequency for each chapter.

In step 67, the two selected keywords are allocated to each page in order of the appearance.

In step 68, a text in the item having the highest appearance frequency of the keywords is automatically summarized in 100 characters from the syllabi, books and the like.

In step 69, the header of the chapter having the highest appearance frequency of the keywords is given to a learning material title.

### (5) The Learning Management System

The learning management system makes determination as to whether or not the variable attribute information is defined, and at the time when the learning is started, reads the information, while at the time when the learning is finished, executes writing of the appropriately updated information so as to be available for another learning management system. In the actual processing, the variable attribute information may be stored in an external storage device or a memory.

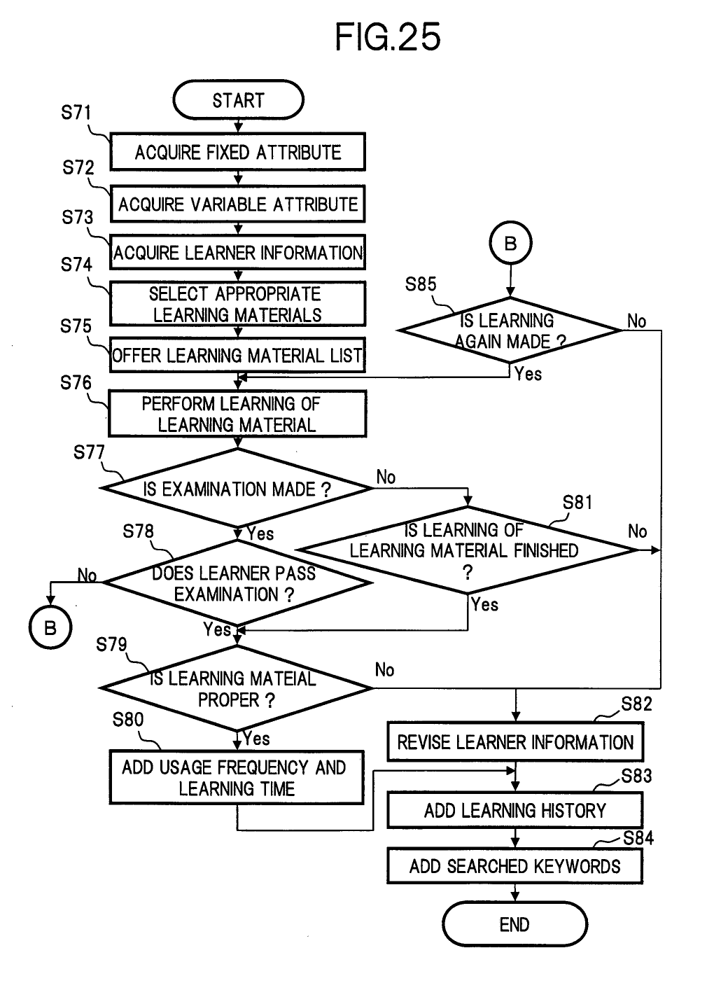

FIG. 25 shows the outline of the processing of from the learning start to the learning finish which is executed in the learning management system 10 when a query in which a search keyword is designated is received.

In step 71, the fixed attribute of the learning material information is acquired.

In step 72, the variable attribute of the learning material information is acquired.

In step 73, the learner information of the learning applicant is acquired.

In step 74, the variable attribute of the learning material information and the variable attribute of the learner information are brought into matching with each other, and a plurality of learning materials considered to be adapted to the learning applicant is selected.

In step 75, the learning material list is offered to the learning applicant.

In step 76, the learning material selected by the learning applicant is provided to be learned.

In step 77, it is determined whether or not the examination is contained in the learning material. Then, if the examination is contained in the learning material, the processing proceeds to step 78 (Yes), while if any examination is not contained in the learning material, the processing proceeds to step 81 (No). Here, the learning material which does not contain any examination is regarded to be, for example, the one for explaining a certain keyword, which is to be read for the learning.

In step 78, it is determined whether or not the learner passed the examination, via whether or not the examination result is equal to or higher than previously assumed score. Then, if the learner passed the examination, the processing proceeds to step 79 (Yes). On the other hand, if the learner could not pass the examination, the processing proceeds to step 85 (No), to make the learner to select whether or not the learner shall learn again. Then, when the learner learns again, the processing returns to step 76 (Yes), while if the learner does not learn again, the processing proceeds to step 82 (No).

In step 79, the learner is made to select whether or not the learning material was proper, that is, whether or not the learning material was adapted to the learner. Then, if the learning material was proper, the processing proceeds to step 80 (Yes), while if the learning material was improper, the processing proceeds to step 82 (No).

In step 80, the usage history, the learning time and the like are additionally registered in the variable attribute of the learning material information, and the processing proceeds to step 83.

In step 81, it is determined whether or not the learning of the learning material is finished. Then, if the learning of the learning material is finished, the processing proceeds to step 79 (Yes), while if the learning of the learning material is not yet finished, the processing proceeds to step 82 (No).

In step 82, the variable attribute of the learner information is revised.

In step 83, the learning history is additionally registered in the variable attribute of the learner information.

In step 84, the searched keyword is additionally registered in the variable attribute of the learning material information.

In the processing as described in the above, the variable attribute is updated before the learning is finished. This update is for avoiding a trouble such that the history is not stored, although “finish” is displayed in an inadvertent situation. In fact, this update is derived from a consideration result that it is safe not to run into a learning finish status before all the information is stored.

Here, the consideration of “learning transaction” is taken in for utilization. This learning transaction indicates, in the case where a small module is assumed, all the processing cycles necessary for the learning thereof. To be specific, one learning transaction is for enabling the learning management in module unit, which is comprised of: “preprocessing” for selecting an optimum module from the attribute of the learner and learning material, the search keywords and the like; “learning action” for learning actually using the learning material and for conducting the examination and questionnaires; and “post-processing” for storing various information generated in the learning action.

### (6) Realization of the Learning Appropriate for the Ability of the Learner

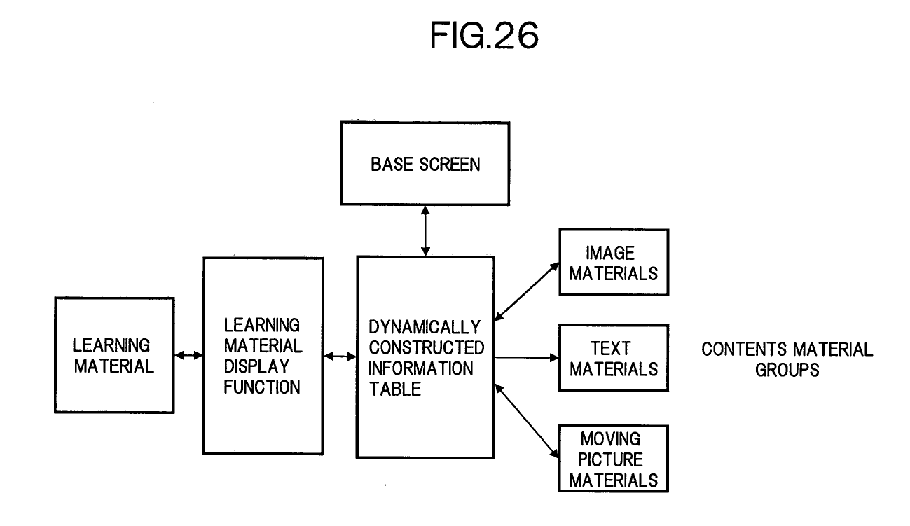

As shown in FIG. 26, reference is made to a dynamically constructed information table, and materials are properly selected to be arranged on a base screen, from contents-material-groups comprised of image materials, text materials, moving picture materials and the like, so that the learning material adapted to the ability of the learner is prepared for providing it to the learner.

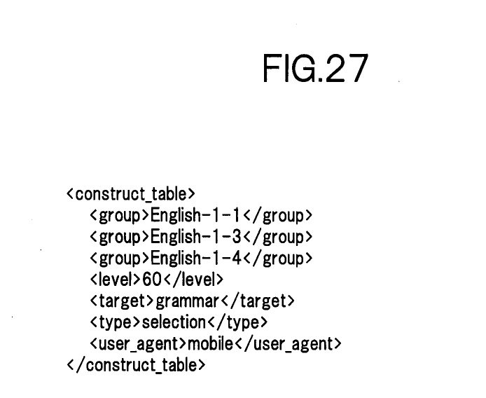

Here, the dynamically constructed information table defines conditions for selectively learning a learning object in small module unit, as shown in FIG. 27. As such conditions, for the English learning material for example, there are assumed the case where the learner intends to learn “grammar in general”, the case where the learner intends to learn in pinpoint only a portion of “tense” and the like. If such conditions are defined, the learning material is divided into a small learning module for each topic, so that only the necessary portion can be learned. If this definition is further developed, it is possible to consider one question as one learning module.

At this time, the selection of topics, a range of the difficulty level of questions and the like are customized to be “the dynamically constructed information table”. To be specific, there are the table in which conditions of the question selecting are defined, the table in which question styles are defined, and the like. These tables may be previously prepared as learning material sets, or may be prepared by the learner’ selection at the time when the learning is started.

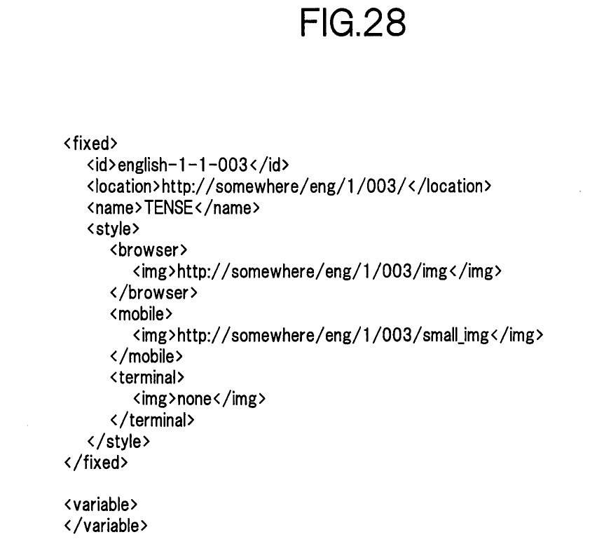

Incidentally, the dynamically constructed information table shown in the figure defines that a group “English-1-3” is skipped, and grammatical questions of around the level 60 are to be set in a selective answer style. On the other hand, style information as shown in FIG. 28 is embedded in the fixed attribute of the learning material information. In the dynamically constructed information table shown in FIG. 27, since “mobile” is designated for “user_agent”, the learning management system sets questions in accordance with this specification.

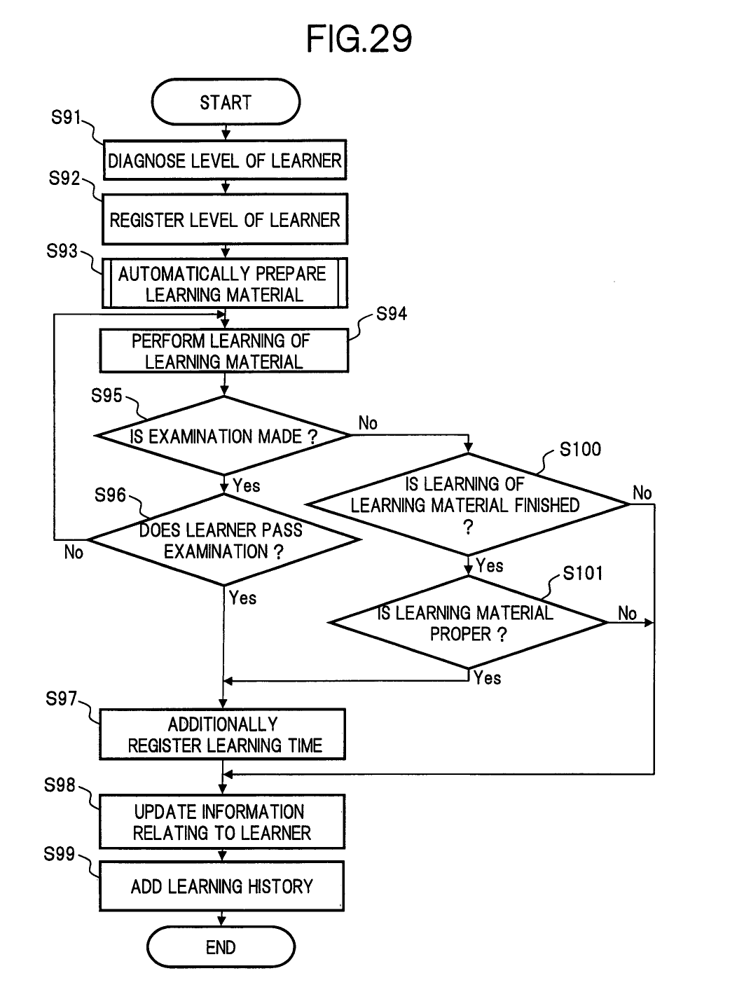

FIG. 29 shows a main routine of the processing of providing the learning material appropriate for the ability of the learner.

In step 91, the level of the learner is diagnosed by any method.

In step 92, the level of the learner is registered in the variable attribute of the learner information.

In step 93, a sub-routine for automatically preparing the learning material is called up.

In step 94, the learning material which is automatically prepared is provided for the learner, to be learned.

In step 95, it is determined whether or not the examination is contained in the learning material. Then, if the examination is contained in the learning material, the processing proceeds to step 96 (Yes), while if any examination is not contained in the learning material, the processing proceeds to step 100 (No).

In step 96, it is determined whether or not the learner passed the examination, via whether or not the examination result is equal to or higher than the previously assumed score. Then, if the learner passed the examination, the processing proceeds to step 97 (Yes), while if the learner could not pass the examination, the processing returns to step 94 (No).

In step 97, the learning time is additionally registered in the variable attribute of the learning material information.

In step 98, the information relating to the learner registered in the variable attribute of the learner information is updated.

In step 99, the learning history is additionally-registered in the variable attribute of the learner information.

In step 100, it is determined whether or not the learning of the learning material is finished. Then, if the learning of the learning material is finished, the processing proceeds to step 101 (Yes), while if the learning of the learning material is not yet finished, the processing proceeds to step 98 (No).

In step 101, the learner is urged to select whether or not the learning material was proper, that is, whether or not the learning material was adapted to the learner. Then, if the learning material was proper, the processing proceeds to step 97 (Yes), while if the learning material was improper, the processing proceeds to step 98 (No).

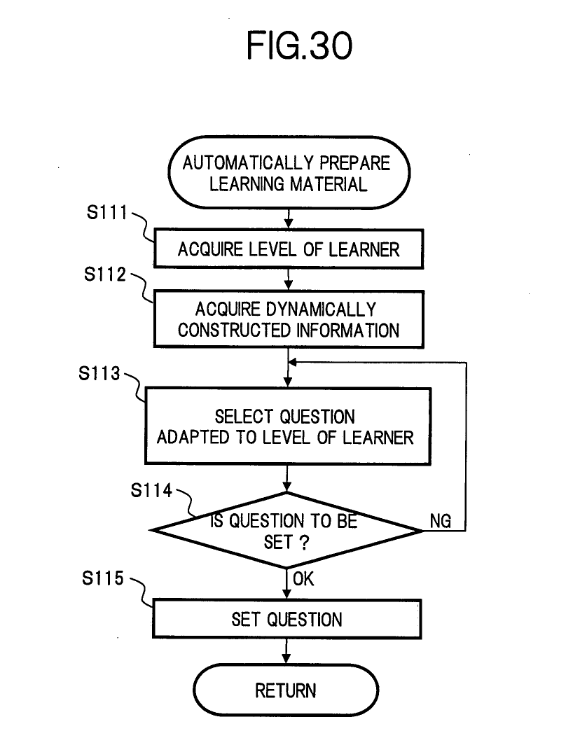

FIG. 30 shows the sub-routine for automatically preparing the learning material.

In step 111, the level of the learner is acquired from the variable attribute of the learner information.

In step 112, reference is made to the dynamically constructed information table, the dynamically constructed information is acquired.

In step 113, a question appropriate for the level of the learner is selected from the learning objects.

In step 114, it is determined whether the selected question should be set to the learner. The determination as to whether or not the selected question should be set is performed based on the dynamically constructed information for each course (task). To be specific, the question which was set in the past examination is to be set again, or a question is set based on the range of the difficulty level of the question, the question style (whether or not figures, hints or the like are to be added), a type of terminal of the learner, and the like. Then, if the selected question should be set, the processing proceeds to step 115 (Yes), where the question is set. On the other hand, if the selected question should not be set, the processing proceeds to step 113 for reviewing a next question (No).

### (7) Reuse of Contents

The reuse of the learning material is to prepare a new learning material by utilizing a part of the existent learning material. To be specific, the deletion of improper items, the addition of lacked items, the extraction of useful portions and the like are made to be performed. For this purpose, it is necessary to make contrivance in that a learning material is prepared in a small unit which is extractable just as it is, to be given with a variable attribute, ranges to be extracted are made understandable, to be given with variable attributes respectively, and so on.

In a method of giving the variable attribute to each extractable range, it is considered to make appropriately the omission/addition of items when the learning material is offered to the learner, without changing the original contents. Consequently, it is possible to utilize portions which were improper in the original learning material as a whole, but are useful in another learning material.

It should be appreciated that the entire contents of Japanese Patent Applications No. 2006-096288, filed on Mar. 31, 2006 and No. 2006-259517, filed on Sep. 25, 2006 are incorporated herein by reference.

It should also be understood that many modifications and variations of the described embodiments of the invention will occur to a person having an ordinary skill in the art without departing from the spirit and scope of the present invention as claimed in the appended claims.

What is claimed is:

1. A computer readable recording medium recorded with a learning management program capable of providing a learning material adapted to a learning applicant via a computer, using a database registered with learning material information including: a fixed attribute specifying learning materials; and a variable attribute by which at least levels specifying an object person of learning are defined, and also capable of realizing in the computer:
a step of receiving a learning request from the learning applicant;
a step of making reference to the variable attribute of the learning material information registered in the database to select a learning material adapted to a level of the learning applicant according to the learning request, when the learning request is received;
a step of providing the selected learning material for the learning applicant; and
a step of updating the variable attribute of the learning material information registered in the database according to a learning result of the learning material.

2. The computer readable recording medium recorded with a learning management program according to claim 1,
wherein the levels defined as the variable attribute of the learning material information are computed based on learning results of all learners who learned the learning material.

3. The computer readable recording medium recorded with a learning management program according to claim 1,
wherein the levels defined as the variable attribute of the learning material information are computed based on learning results of learners refined from all learners who learned the learning material, according to a predetermined rule.

4. The computer readable recording medium recorded with a learning management program according to claim 3,
wherein the predetermined rule is at least one of the learning times and dates of the learning material and the levels of the learners.

5. The computer readable recording medium recorded with a learning management program according to claim 1,
wherein search keywords designated by the learning applicant are contained in the learning request, while searched keywords to be searched according to the search keywords are defined as the variable attribute of the learning material information, and
wherein the step of selecting the learning material comprises making reference to the variable attribute of the learning material information registered in the database, and selecting the learning material adapted to the level of the learning applicant in the learning request, from the learning materials each of which search keywords and searched keywords are matched with each other.

6. The computer readable recording medium recorded with a learning management program according to claim 5, wherein the learning management program further allows the computer to realize:
a step of updating the searched keywords defined as the variable attribute of the learning material information based on the search keywords contained in the learning request.

7. The computer readable recording medium recorded with a learning management program according to claim 6,
wherein the step of updating the searched keywords additionally registers in the variable attribute of the learning material information, the search keyword which is not defined as the variable attribute of the learning material information, among the search keywords contained in the learning request.

8. The computer readable recording medium recorded with a learning management program according to claim 5,
wherein the searched keywords defined as the variable attribute of the learning material information are sorted in descending order according to the usage frequency thereof.

9. The computer readable recording medium recorded with a learning management program according to claim 1,
wherein the step of selecting the learning material comprises:
selecting a plurality of learning materials adapted to the level of the learning applicant according to the learning request while offering a list of the plurality of learning materials selected for the learning applicant, and
urging the learning applicant to select one learning material from the list.

10. The computer readable recording medium recorded with a learning management program according to claim 1,
wherein the database further registers therein learner information comprising: a fixed attribute specifying learners; and a variable attribute for which at least levels specifying abilities of the learners, and the step of selecting the learning material refers to the variable attribute of the learner information registered in the database, to specify the level of the learning applicant according to the learning request.

11. The computer readable recording medium recorded with a learning management program according to claim 10, wherein the learning management program further allows the computer to realize:
a step of updating the variable attribute of the learner information registered in the database according to the learning result of the learning material.

12. A learning management system comprising:
a database recorded with learning material information comprising: a fixed attribute specifying learning materials; and a variable attribute for which at least levels specifying object person of learning are defined;
learning material selecting means for making reference to the variable attribute of the learning material information registered in the database to select a learning material adapted to a level of a learning applicant according to the learning request, when the learning request is received from the learning applicant;
learning material providing means for providing the learning material selected by the learning material selecting means for the learning applicant; and
learning material information update means for updating the variable attribute of the learning material information registered in the database according to a learning result of the learning material provided by the learning material providing means.

13. A learning management method of providing a learning material appropriate for a learning applicant via a computer, using a database registered with learning material information which includes a fixed attribute specifying learning materials; and a variable attribute by which at least levels specifying an object person of learning are defined, the method comprising execution of:
a step of making reference to the variable attribute of the learning material information registered in the database to select a learning material appropriate for a level of a learning applicant in the learning request, when the learning request is received via the computer from the learning applicant;
a step of providing the selected learning material for the learning applicant; and
a step of updating the variable attribute of the learning material information registered in the database according to a learning result of the learning material.
